(19) United States
(12) Patent Application Publication
(10) Pub. No.: US 2024/0229510 A9
(43) Pub. Date: Jul. 11, 2024

(54) METHOD AND APPARATUS FOR SENSING A STATUS OF A DEADBOLT

(71) Applicant: Ecolink Intelligent Technology, Inc., Carlsbad, CA (US)

(72) Inventor: Shing Chen, San Diego, CA (US)

(21) Appl. No.: 18/494,261

(22) Filed: Oct. 25, 2023

Related U.S. Application Data
(60) Provisional application No. 63/418,992, filed on Oct. 25, 2022.

(51) Int. Cl. E05B 47/00

(52) U.S. Cl. CPC E05B 47/00; E05B 2047/005; E05B 2047/0069

(57) ABSTRACT

A method and apparatus for determining a status of a deadbolt assembly. A deadbolt status assembly uses mechanical, ultrasonic, infrared, inductance, and/or capacitance to detect when a deadbolt assembly is in a locked state, where a bolt of the deadbolt assembly is fully extended, or in an unlocked state, where the bolt is fully retracted.

### CROSS-REFERENCE TO RELATED APPLICATIONS

This application claims the benefit of U.S. patent application Ser. No. 63/418,992, filed on Oct. 25, 2022.

### BACKGROUND

### Field of Use

The present application relates generally to the field of premises monitoring and security. More specifically, the present application relates to a method and apparatus of sensing the status of a deadbolt.

### Description of the Related Art

Security systems are widely used to protect homes and businesses. These systems typically employ a number of door and window sensors to monitor the state of doors and windows, i.e., open or closed, and typically additionally employ one or more other sensor types, such as motion sensors, glass break detectors, garage door tilt sensors, etc.

More recently, electronic deadbolts have been introduced to the marketplace. In some cases, these electronic deadbolts are designed to completely replace existing deadbolts. They may be referred to as “smart deadbolts”, because they have the capability to be remotely operated and a status of the deadbolt, i.e., locked or unlocked, can be wirelessly transmitted to users and displayed on smart phones, computers, wearables, etc.

These smart deadbolts have several disadvantages. First and foremost, they tend to be relatively expensive, on the order of $200 or more. Secondly, many consumers do not have the aptitude to remove an existing deadbolt and install a smart deadbolt, requiring additional cost to hire a contractor or handyman to install.

Another type of recently-introduced smart deadbolts include those that install over an existing deadbolt “thumb turn”, i.e., a portion of a deadbolt system that is installed on a door. These smart deadbolts comprise a transceiver and an electronic motor that turns the thumb turn to lock and unlock the deadbolt based on wireless commands received from smart phones, computers, wearables, etc.

These smart deadbolts also suffer from several disadvantages. For example, they tend to be bulky and unsightly. They also tend to be expensive, on the order of $150 or more.

It would be desirable to monitor the status of a deadbolt without having to expend large amounts of money and to avoid complicated mechanical replacement.

### SUMMARY

The embodiments described herein relate various embodiments of a deadbolt sensor assembly for detecting to he status of a common, already-installed, mechanical deadbolt assembly i.e., whether the deadbolt assembly is in a locked state or an unlocked state, i.e., whether a deadbolt of the deadbolt assembly has been “thrown” or “extended”, or “not thrown” or “retracted”, respectively. In one embodiment, an apparatus is described for determining a status of a deadbolt assembly, comprising a sleeve for receiving a deadbolt of the deadbolt assembly when the deadbolt assembly is in a locked position, sized and shaped to fit within an existing deadbolt recess formed into a door jamb, a deadbolt sensor fixedly coupled to a distal end cap of the sleeve, away from a proximal, open end of the sleeve, a processor coupled to the deadbolt sensor for determining the status of the deadbolt assembly, and a transmitter coupled to the deadbolt sensor for wireless transmitting the status of the deadbolt.

### BRIEF DESCRIPTION OF THE DRAWINGS

The features, advantages, and objects of the present invention will become more apparent from the detailed description as set forth below, when taken in conjunction with the drawings in which like referenced characters identify correspondingly throughout, and wherein:

FIG. 1 is a perspective view of one embodiment of a deadbolt sensor assembly;

FIG. 2 is a side, cut-away view of the deadbolt sensor assembly shown in FIG. 1, mounted to a door frame and in use with an existing deadbolt assembly mounted to an existing door;

FIG. 3 is a side, cutaway view of the deadbolt sensor assembly as shown in FIGS. 1 and 2, with the addition of an elastic block inside a sleeve of the deadbolt sensor assembly, in an embodiment that accounts for different lengths of a deadbolt;

FIG. 4 is a side, cutaway view of another embodiment of a deadbolt sensor assembly, with a sensor of the deadbolt sensor assembly mechanically coupled externally to an end cap of a sleeve of the deadbolt sensor assembly;

FIG. 5 is a perspective view of another embodiment of a deadbolt sensor assembly, comprising a self-contained, movable sensor assembly attached to a wall or a doorframe at a position directly over at least a portion of a deadbolt recess formed into a doorjamb;

FIG. 6 is a plan view of the deadbolt sensor assembly as shown in FIG. 5, mounted to a wall or a doorframe with the sleeve, a strike plate and a deadbolt shown in hidden view;

FIG. 7 is a functional block diagram of any of the wireless sensor assemblies as shown in FIGS. 1-6 and 8;

FIG. 8 is yet another embodiment of a deadbolt sensor assembly;

FIG. 9 illustrates the deadbolt sensor assembly as shown in FIG. 8, positioned inside a deadbolt recess and towards a distal end of the deadbolt recess; and

FIG. 10 is a side, cutaway view of the deadbolt sensor assembly as shown in FIGS. 8 and 9 inside the deadbolt recess when a deadbolt assembly is in a locked state.

### DETAILED DESCRIPTION

The present description relates to deadbolt sensor assembly for monitoring a status of a deadbolt assembly, i.e., whether the deadbolt assembly is in a locked state, i.e., a bolt of the deadbolt assembly has been is “thrown” or “extended”, or in an unlocked state, i.e., “not thrown” or “retracted”. Primary design considerations of such a deadbolt sensor assembly include cost, ease of installation and battery life.

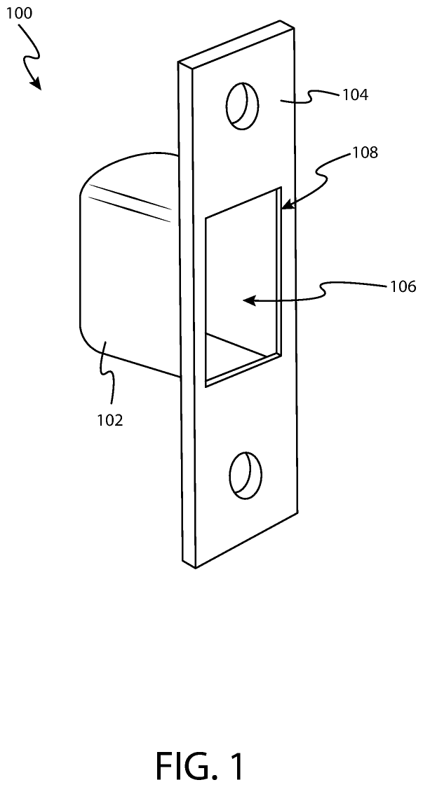

FIG. 1 is a perspective view of one embodiment of a deadbolt sensor assembly 100. In this embodiment, deadbolt sensor assembly 100 comprises a hollow sleeve 102, a strike plate 104 and a wireless sensor assembly (hidden in this view) mounted inside or externally to sleeve 102. Advantageously, deadbolt sensor assembly 100 typically comprises a single unit, making installation easy by simply removing an existing deadbolt strike plate on a door jamb, and replacing it with deadbolt sensor assembly 100. It should be understood that the components of deadbolt sensor assembly 100 as shown in FIG. 1 may not be to scale with respect to each other. This pertains to all of the figures in each of the drawings associated herewith. Sleeve 102 comprises an encapsulated or semi-encapsulated metal or plastic receptacle with a proximal, open end 108 of sleeve 102 that defines a perimeter of a void 106, the void sized and shaped to substantially match a cross-section of a typical deadbolt. In some embodiments, void 106 comprises a round, square, hexagonal or some other geographical shape that does not substantially match a cross-section of a deadbolt. In these embodiments, void 106 is shaped large enough in diameter to receive a deadbolt, without regard to a particular cross-sectional shape of the deadbolt. Sleeve 102 is sized and shaped to be installed into an existing deadbolt recess in a doorjamb. The length of sleeve 102 is generally longer than a protruding length of a deadbolt into void 106, so that the deadbolt does not impact the deadbolt sensor assembly inside sleeve 102, in embodiments where deadbolt sensor assembly 100 is mounted inside sleeve 102.

In this disclosure, the term “deadbolt assembly” comprises all components of a standard, mechanical deadbolt lock, including such items as a bolt and a lock body, which is a cylindrical casing that holds all of the locking components in place, such as a bolt hub, bolt actuator, thumb turn, etc. The term “bolt” refers specifically to a rigid member that extends from the lock body and into a deadbolt recess formed into a doorjamb when the deadbolt assembly is in a locked position.

It should be understood that in some embodiments, sleeve 102 is not used. In this embodiment, the deadbolt sensor assembly may be placed directly inside a deadbolt recess formed in a doorjamb that receives a bolt of a deadbolt assembly.

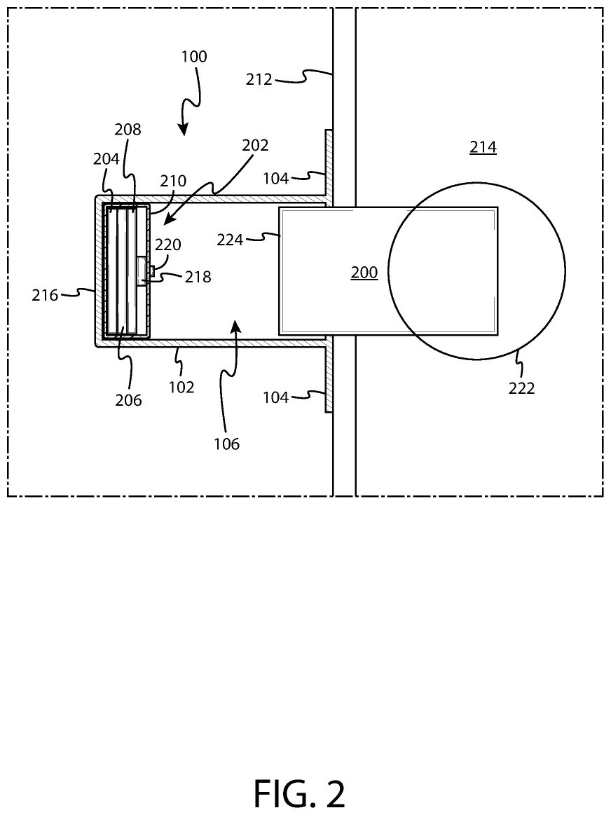

FIG. 2 is a side, cut-away view of deadbolt sensor assembly 100 mounted to a door frame 212 and in use with an existing deadbolt assembly 222 mounted to an existing door 214. The existing deadbolt assembly 222 is shown in an extremely simplified rendering, because it is not necessary to include prior-art details of deadbolt assemblies for the understanding of the inventive concepts herein.

Bolt 200 comprises a non-deformable longitudinal member, typically made from one or more metals. Bolt 200 extends into void 106 while deadbolt assembly 222 is placed into a locked position. Conversely, bolt 200 is retracted into door 214, and out of void 106, while deadbolt assembly 222 is placed in an unlocked position. As mentioned earlier, deadbolt sensor assembly 100 comprises a wireless sensor assembly 202 mounted, in this embodiment, inside sleeve 102 and abutting, or near, a distal end cap 216 of sleeve 102, opposite proximal, open end 108 of sleeve 102.

Wireless sensor assembly 202 comprises a housing 210 containing a battery 204, a circuit board 206, electronic circuitry 208 and a sensor 218. It should be understood that although wireless sensor assembly 202 is shown in FIG. 2 as comprising layers of components, in other embodiments the arrangement of battery 204, circuit board 206, electronic circuitry 208 and sensor 218 may be arranged differently.

Wireless sensor assembly 202 may comprise a unitary structure, having a cross-section that substantially matches an interior cross-section of void 106. In other embodiments, the cross-section of wireless sensor assembly 202 may simply be smaller than the smallest cross-sectional dimension of void 106, such that wireless sensor assembly 202 may be placed inside sleeve 102 but not match the cross-section of void 106. Wireless sensor assembly 202 may be installed against end cap 216 within sleeve 102 and held in place using well-known techniques such as gluing or manual fixation (i.e., using screws or rivets), by mechanical stops mounted inside sleeve 102, etc. Battery 204 provides DC power to circuit board 206 and electronic components 208, including sensor 218, in order to power such components. Typically, battery 204 comprises a coin cell battery at a voltage between two and five volts. Circuit board 206 comprises a standard single or multi-layer printed circuit board, comprising a cross-section matching an interior of housing 210, typically circular in size. Electronic components 208 comprise electronic circuitry used to at least transmit status signals to a local receiver, such as a hub, security panel, mobile phone, wearable device, etc., typically located within a same structure where deadbolt sensor assembly 100 is located. In some embodiments, electronic components 208 comprise a receiver as well, in order to receive wireless signals from a local receiver, such as commands for deadbolt sensor assembly 100 to perform certain actions, such as to report the present, or previous, statuses of deadbolt assembly 222. Sensor 218 comprises one or more mechanical, ultrasonic, infrared, capacitive, inductive, or some other sensing device that can detect when a deadbolt extends into void 106 and when the deadbolt has been retracted inside a door.

In one embodiment, sensor 218 comprises a mechanical plunger switch that changes state when an end 224 of bolt 200 comes in contact with a plunger 220 of sensor 218, depressing plunger 220 as bolt 200 is thrown, and releasing plunger 220 when bolt 200 is retracted.

In another embodiment, sensor 218 comprises in ultrasonic transceiver that transmits ultrasonic sound periodically, such as once every minute. The ultrasonic sound strikes end 224 of bolt 200 and is reflected back towards the ultrasonic transceiver. A processor of electronic circuitry 208 and coupled to the ultrasonic transceiver may then calculate a distance between the transceiver and the end of bolt 200, as is well-known in the art. When the distance is less than a predetermined distance, such as ¼ of an inch, the processor may determine that bolt 200 has been thrown, indicating that deadbolt assembly 222 is in a locked state. When the processor detects that end 224 of bolt 200 is greater than a second predetermined distance away from the ultrasonic transceiver, representing bolt 200 clearing strike plate 104, such as 3 inches, the processor may determine that bolt 200 has been retracted and that deadbolt assembly 222 is in an unlocked position.

In some embodiments, the ultrasonic transceiver may be calibrated by measuring the distance between the ultrasonic transceiver and end 224 of bolt 200 when thrown into the deadbolt recess and then again measuring the distance between the ultrasonic transceiver and end 224 of bolt 200 after placing bolt 200 into a fully retracted position. These readings may then be stored in a memory coupled to the processor and used to create threshold distances related to bolt 200 either being extended or retracted into the deadbolt recess.

In another embodiment, sensor 218 comprises an infrared transceiver that transmits infrared light periodically, such as once every minute. The infrared light strikes end 224 of bolt 200 and is reflected back towards the infrared transceiver. A processor of electronic circuitry 208 is coupled to the infrared transceiver and may then calculate a distance between the transceiver and end 224 of bolt 200, as is well-known in the art. When the distance is less than a predetermined distance, such as ¼ of an inch, the processor may determine that bolt 200 has been thrown, indicating that deadbolt assembly 222 is in a locked state. When the processor detects that end 224 of bolt 200 is greater than a second predetermined distance away from the ultrasonic transceiver, representing bolt 200 clearing strike plate 104, such as 3 inches, the processor may determine that bolt 200 has been retracted and that deadbolt assembly 222 is in an unlocked position.

In some embodiments, the infrared transceiver may be calibrated by measuring the distance between the infrared transceiver and end 224 of bolt 200 when thrown into the deadbolt recess and then again measuring the distance between the ultrasonic transceiver and end 224 of bolt 200 after placing bolt 200 into a fully retracted position. These readings may then be stored in a memory coupled to the processor and used to create threshold distances related to bolt 200 either being extended or retracted into the deadbolt recess.

In yet another embodiment, sensor 218 comprises a capacitance sensor that senses changes in capacitance as bolt 200 approaches the capacitance sensor as it is being thrown. Capacitive sensors are electronic devices that can detect solid or liquid targets without physical contact. To detect these targets, capacitive sensors typically emit an electrical field. Any target that disrupts this electrical field is detected. Thus, as bolt 200 approaches the capacitance sensor as it is being thrown, bolt 200 interferes with the electrical field and changes a capacitance that is measured by the capacitance sensor. This change in capacitance, or a series of measured capacitances, is provided to a processor coupled to the capacitance sensor, and the processor determines when the capacitance has exceeded a predetermined capacitance, or when the rate of change of the measured capacitance increases more than a predetermined rate, indicating that bolt 200 has been thrown. Similarly, the processor can determine when bolt 200 has been retracted when the measured capacitance falls below a second predetermined capacitance or when the rate of change of the measured capacitance decreases more than a second predetermined rate.

In some embodiments, the capacitance sensor may be calibrated by measuring a capacitance when bolt 200 has been thrown into the deadbolt recess and then again measuring the capacitance when bolt 200 is fully retracted. These readings may then be stored in a memory coupled to the processor and used to create threshold capacitances related to bolt 200 either being extended or retracted into the deadbolt recess.

Similarly, in yet another embodiment, sensor 218 comprises an inductance sensor that senses changes in inductance as bolt 200 approaches the inductance sensor when it is being thrown. Inductance sensors are electronic devices that can detect solid or liquid targets without physical contact. To detect these targets, inductance sensors emit an electrical field. Any target that disrupts this electrical field is detected. Thus, as bolt 200 approaches the inductance sensor as it is being thrown, bolt 200 interferes with the electrical field and changes an inductance that is measured by the inductance sensor. This change in inductance, or a series of measured inductances, is provided to a processor coupled to the inductance sensor, and the processor determines when the inductance has exceeded a predetermined inductance, or when the rate of change of the measured inductance increases more than a predetermined rate, indicating that bolt 200 has been thrown. Similarly, the processor can determine when bolt 200 has been retracted when the measured inductance falls below a second predetermined inductance or when the rate of change of the measured inductance decreases more than a second predetermined rate.

In some embodiments, the inductance sensor may be calibrated by measuring an inductance when bolt 200 has been thrown into the deadbolt recess and then again measuring the inductance when bolt 200 is fully retracted. These readings may then be stored in a memory coupled to the processor and used to create threshold capacitances related to bolt 200 either being extended or retracted into the deadbolt recess.

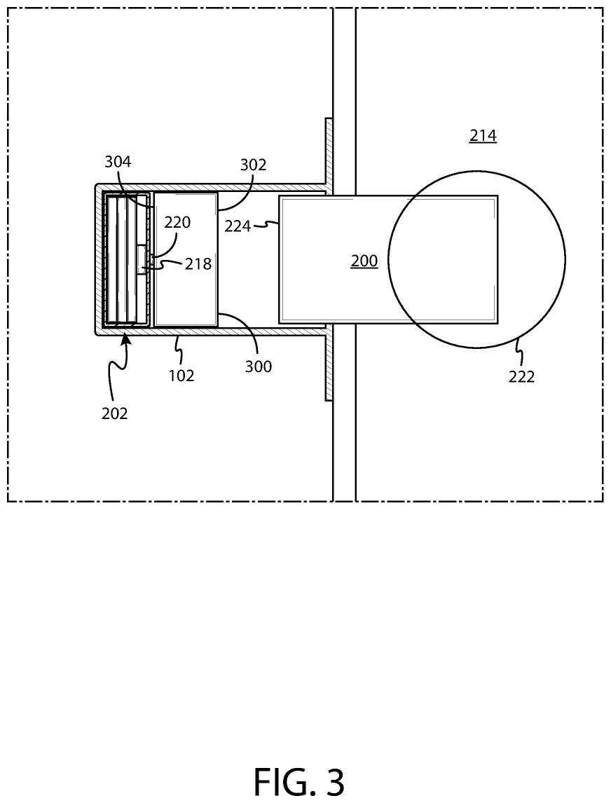

FIG. 3 is a side, cutaway view of the deadbolt sensor assembly 100 as shown in FIG. 2, with the addition of an elastic block 300 inside sleeve 102, as shown, in an embodiment that accounts for different lengths of bolt 200 as well as different lengths of void 106. In this embodiment, sensor 218 comprises a mechanical plunger switch. In many instances, in different installations, the length of bolt 200 protruding from door 214 in an extended position may vary by as much as an inch. Similarly, a recess formed into a door frame that receives bolt 200 may vary in length from one installation to another. To account for these differences, elastic block 300 may be inserted into sleeve 102 after wireless sensor assembly 202 has been installed. Elastic block 300 is manufactured from an elastic material, such as natural rubber, synthetic rubber, certain polymers, etc., sized and shaped to fit within void 106. In some embodiments, a diameter of elastic block 300 is slightly larger than a diameter of void 106, so that elastic block 300 must be slightly deformed in order to fit within void 106. This aids in retaining elastic block 300 inside sleeve 102.

As shown in FIG. 3, elastic block 300 is typically positioned near sensor 218 upon insertion, and in an uncompressed state. Sensor 218 is in a non-depressed state. When bolt 200 is thrown, it acts against a first end 302 of elastic block 300, causing elastic block 302 compress and for a second, opposing end 304 two move against plunger 220, thereby depressing the mechanical plunger switch. When bolt 200 is retracted into door 214, elastic block 300 is allowed to decompress back into its original shape, and second end 304 moves away from plunger 220, thereby causing the mechanical plunger switch to change state.

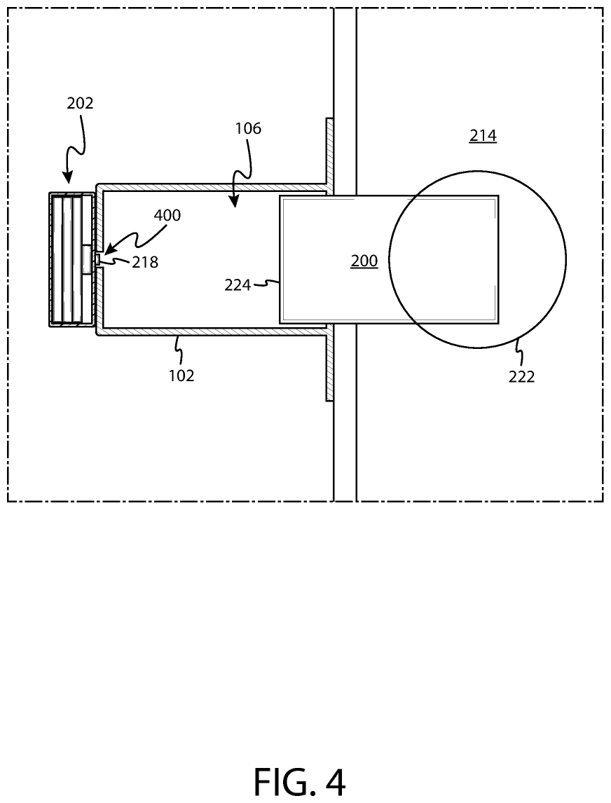

FIG. 4 is a side, cutaway view of another embodiment of a deadbolt sensor assembly 100, with wireless sensor assembly 202 mechanically coupled externally to end cap 216 of sleeve 102, as shown. In this embodiment, wireless sensor assembly 202 comprises the same components as described earlier herein, however end cap 216 comprises aperture 400 located substantially in a center portion of end cap 216. In other embodiments, aperture 400 may be located at a different portion of end cap 216. Generally, any of the aforementioned sensors can be used in this embodiment, for example, a mechanical switch, an ultrasonic transceiver, an infrared transceiver, a capacitance sensor, and inductance sensor, etc.

Wireless sensor assembly 202 is mechanically coupled externally to end cap 216 using traditional methods, such that sensor 218 is in alignment with aperture 400. In some embodiments, sensor 218 extends into aperture 400 and, in some embodiments, into void 106. A diameter of wireless sensor assembly 202 is less than or equal to an outside diameter of sleeve 102, such that wireless sensor assembly 202 does not interfere with installation of deadbolt sensor assembly 100 into an existing recess of a doorjamb.

As before, wireless sensor assembly 202 may check void 106 continuously or periodically by monitoring switch 218, by transmitting ultrasonic sound or infrared light through aperture 400 and into void 106, or by measuring a capacitance or inductance. When bolt 200 is thrown, a processor coupled to sensor 218 detects a change in state of a plunger of a mechanical switch, that the distance between sensor 218 and the end of bolt 200 is less than a predetermined amount, that a capacitance/inductance has changed more than a predetermined amount or exceeded a threshold capacitance/inductance, etc.

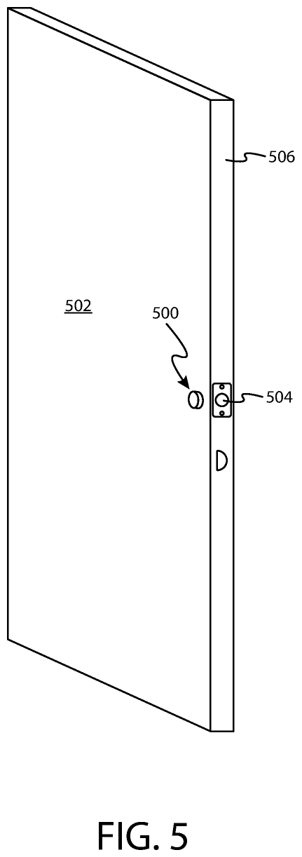

FIG. 5 is a perspective view of another embodiment of deadbolt sensor assembly 100, comprising a self-contained, movable sensor assembly 500 attached to a wall or doorframe 502 at a position directly over at least a portion of a deadbolt recess 504 formed into doorjamb 506. Door 214 and deadbolt assembly 222 are not shown in this view, for purposes of clarity. In this embodiment, sensor assembly 500 comprises electronics needed to determine when bolt 200 has been thrown or retracted into/from deadbolt recess 504, through wall/doorframe 502, and transmit a status of bolt 200 to a local receiver. Sensor assembly 500 may comprise an adhesive deposited on a flat surface of sensor 500, such as a “peel and stick” adhesive, for attaching sensor 502 wall/doorframe 502.

Sensor assembly 500 is shown as being mounted directly over void 106, approximately midway between end cap 216 and deadbolt strike plate 104, although it may be located slightly to the left or to the right. In general, sensor assembly 500 is mounted on wall/door frame 502 such that it is capable of sensing bolt 200 when it is thrown and detecting when bolt 200 has been retracted.

Sensor assembly 500 comprises the same or similar components as wireless sensor assembly 202, i.e., a battery, a circuit board, electronic circuitry and a sensor for detecting the presence or absence of deadbolt 204 within void 106. The electronic circuitry comprises at least transmitter for transmitting the status of bolt 200 to a local receiver. In some embodiments, the electronic circuitry additionally may comprise a transmitter-receiver combination. The sensor within sensor assembly 500 typically comprises an ultrasonic sensor, a capacitance sensor and/or an inductance sensor to determine whether bolt 200 has been thrown or has been retracted.

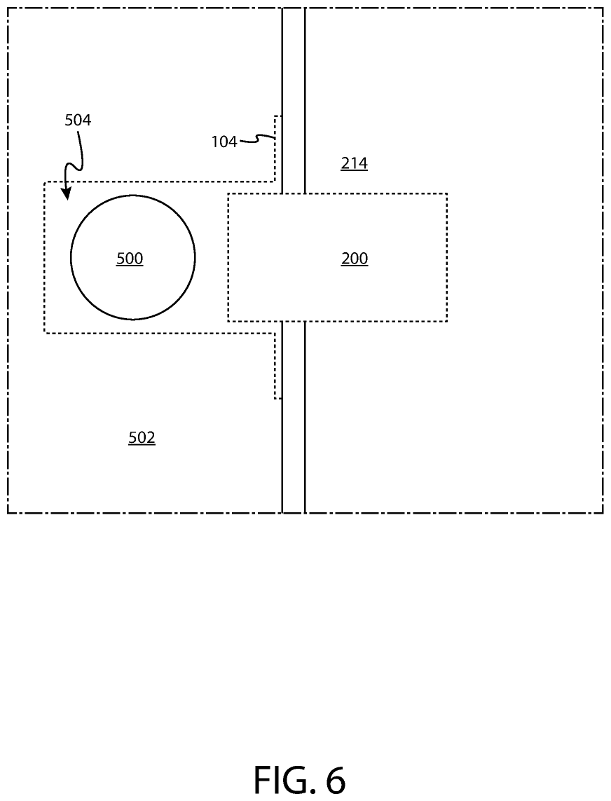

FIG. 6 is a plan view of sensor 500 mounted to wall/doorframe 502 with deadbolt recess 504, strike plate 104 and bolt 200 shown in hidden view. It should be understood that in another embodiment, sleeve 102 may be used but not comprise wireless sensor assembly 202. While sensor assembly 500 is shown having a circular cross-section in FIG. 2, in other embodiments, sensor assembly 500 could comprise virtually any geographic shape. Sensor 500 is typically small, with a diameter slightly larger than a typical coin cell battery used to power sensor 500. It may be desirable to limit the size of sensor assembly 500, to limit the visual impact sensor 500 may have in proximity to a door and/or related hardware, such as a deadbolt assembly, doorknob, etc.

Ideally, sensor assembly 500 is mounted to wall/doorframe 502 substantially over void 106 as shown. Ideally, sensor assembly 500 is located such that when bolt 200 is thrown, bolt 200 resides directly behind the entirety of sensor assembly 500. When bolt 200 is thrown, a sensor within sensor assembly 500 detects a reflection of ultrasonic sound, a capacitance or an inductance, and sends an electronic measurement of these readings to a processor coupled to the sensor, and the processor determines when bolt 200 is present or not present, based on predetermined thresholds, or rates of change of the signals, stored in a memory coupled to the processor.

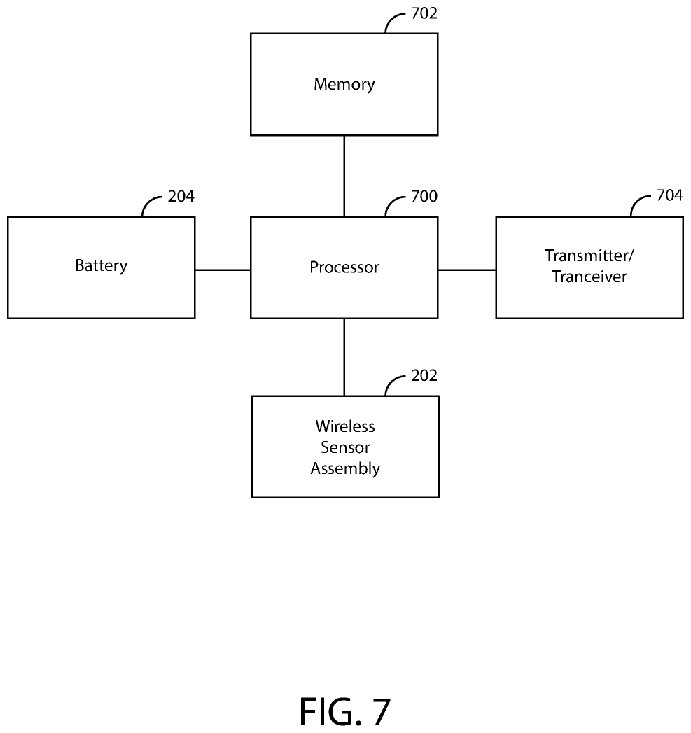

FIG. 7 is a functional block diagram of wireless sensor assembly 202 or sensor assembly 500, comprising processor 700, memory 702, transmitter 704, and wireless sensor assembly 202. Processor 700 is part of electronic circuitry model 208 in the electronic circuitry within sensor assembly 500, configured to provide general operation of wireless sensor assembly 202 or sensor assembly 500 by executing processor-executable instructions stored in memory 702, for example, executable code. Processor 700 typically comprises a general-purpose computing device, such as an ADuC7024 analog microcontroller manufactured by Analog Devices, Inc. of Norwood Massachusetts, although any one of a variety of microprocessors, microcomputers, and/or microcontrollers may be used alternatively, selected to meet the requirements of a small, battery-powered, consumer-grade sensor such as low power consumption, small size and low cost.

Memory 702 comprises one or more information storage devices, such as RAM, ROM, flash memory, or virtually any other type of electronic memory device. Memory 702 is used to store the processor-executable instructions for operation of wireless sensor assembly 202 or sensor assembly 500 as well as information provided by wireless sensor assembly 202. Memory 702 is non-transitory and does not include propagating signals. In some embodiments, memory 702 may be incorporated within processor 700, as is the case in many microprocessors and microcontrollers.

Transmitter 704 is coupled to processor 700 and is also part of electronic circuitry, comprising electronic circuitry necessary for wireless sensor assembly 202 or sensor assembly 500 to wirelessly transmit signals to a local receiver, such as an Internet router, security hub or panel, a general-purpose IoT monitoring gateway, a smart device such as a mobile phone, tablet computer, wearable device, etc. using techniques well-known in the art. Transmitter 704 typically comprises circuitry for local communications, such as Wi-Fi circuitry, Bluetooth circuitry, mesh network circuitry (such as Zwave or Zigbee), etc. in some embodiments, wireless sensor assembly 202 or sensor assembly 500 additionally comprises wireless receiver circuitry to wirelessly receive signals from the local receiver.

Sensor 202 is coupled to processor 700, comprising one or more of a mechanical switch, an ultrasonic transceiver, and infrared transceiver, a capacitance sensor, or an inductance sensor. Such sensors are well known in the art.

Battery 204 comprises a low-voltage, DC battery, typically a coin cell, at a voltage of approximately 2-5 volts.

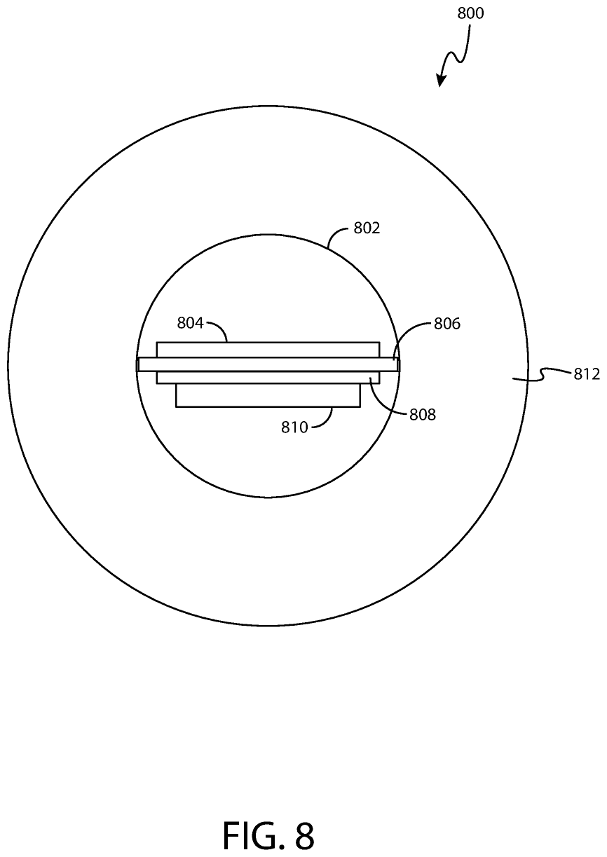

FIG. 8 is yet another embodiment of a deadbolt sensor assembly 800. In this embodiment, deadbolt sensor assembly 800 comprises a housing 802 containing a battery 804, a circuit board 806, electronic circuitry 808 comprising a processor, a memory, and a transmitter or transceiver, and a sensor 810. Battery 804, circuit board 806, electronic circuitry 808 and sensor 810 are the same or similar to battery 204, circuit board 206, electronic circuitry 208 and sensor 218 of FIG. 2, respectively, while the processor, memory and transmitter/transceiver are the same or similar to processor 700, memory 702 and transmitter/transceiver 704. Sensor 810 is the same or similar to sensor 218 as shown in FIG. 2, comprising a capacitance sensor or an inductance sensor.

It should be understood that although deadbolt sensor assembly 800 is described and shown as being spherical, in other embodiments, housing 802 may comprise a different shape, such as a cube, a cuboid, an ovoid, etc.

Housing 802 may be surrounded by an elastic covering 812, comprised of foam rubber, natural rubber, or some other natural or man-made material capable of deformation when acted on by a force and, typically, capable of returning to an original shape after the force has been removed. For example, when deadbolt sensor assembly 800 is compressed in a user's hand, a diameter of elastic covering 812 is reduced, making deadbolt sensor assembly 800 smaller in size. When the user releases deadbolt sensor assembly 800, elastic covering 812 resumes its original shape and size.

It should be understood that elastic covering 812 is described and shown as being spherical, in other embodiments, it may comprise a different shape, such as a cube, a cuboid, and ovoid, etc.

In practice, deadbolt sensor assembly 800 may be initially activated using prior art techniques, such as to pull a mylar tab extending from elastic covering 812 (not shown), thereby coupling battery 804 to electronic circuitry 808. Deadbolt sensor assembly 800 may alternatively be activated by squeezing elastic covering 812 which causes a change in a capacitance or an inductance measured by sensor 810. In this embodiment, deadbolt sensor assembly 800 initially operates in a quiescent state and is activated upon detection of a change in capacitance or inductance. In yet another embodiment, deadbolt sensor assembly 800 is activated by shaking deadbolt sensor assembly 800 and embodiment where electronic circuitry 808 comprises an accelerometer or the like. In this embodiment, deadbolt sensor assembly 800 initially operates in a quiescent state and is activated upon detection of a change in acceleration that exceeds a predetermined amount, enough to activate deadbolt sensor assembly 800.

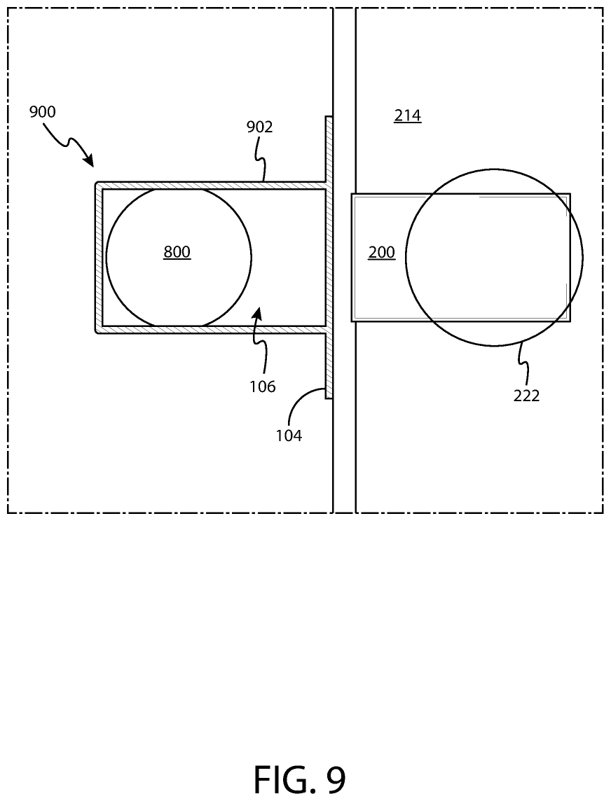

After deadbolt sensor assembly 800 has been activated, a user inserts it into a deadbolt recess of a doorjamb or into a sleeve, if one has been already installed into the doorjamb. The diameter of elastic covering 812 is typically slightly larger than the diameter of the deadbolt recess or sleep. Due to the elastic nature of elastic covering 812, once inside, elastic covering 812 expands against an interior surface of the deadbolt recess or sleeve, securing deadbolt sensor assembly 800 in place. Typically, deadbolt sensor assembly 800 is positioned at work towards a distal end of the deadbolt recess or sleeve, i.e., away from the opening of the deadbolt recess or sleeve. FIG. 9 illustrates these concepts, showing deadbolt sensor assembly 800 positioned inside deadbolt recess 902 forming void 106 (without a sleeve), and towards distal end 900 of deadbolt recess 902. As shown, elastic covering 812 is compressed at the top and bottom of recess 902 and, in fact, all around the perimeter of elastic covering 812 in three dimensions.

Upon activation and insertion into recess 902, deadbolt sensor assembly 800 may take an initial capacitance or inductance reading while bolt 200 is retracted, in order to get a base line capacitance or inductance associated with deadbolt assembly 222 being in an unlocked state.

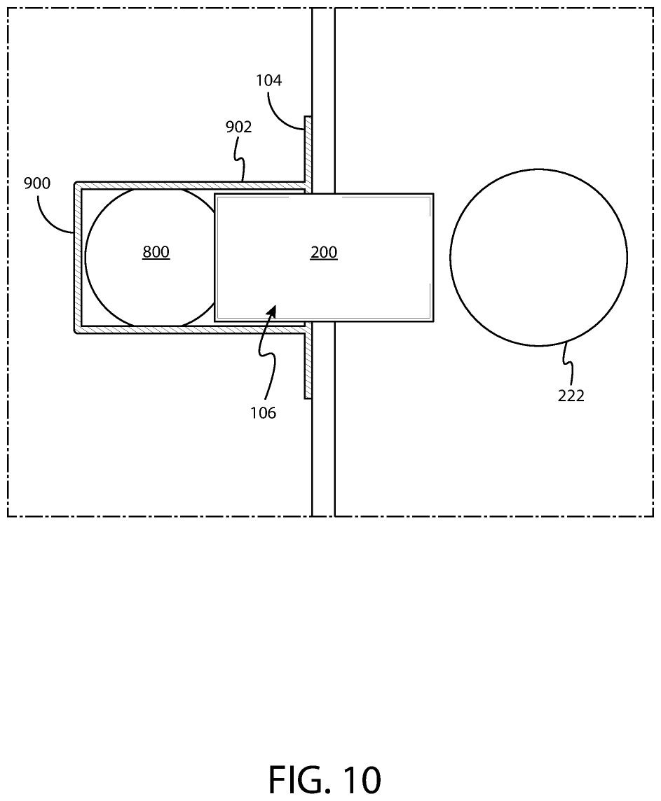

FIG. 10 is a side, cutaway view of deadbolt sensor assembly 800 inside recess 902 when deadbolt assembly 222 is in a locked state. In this state, bolt 200 has been fully extended into void 106 of recess 902 and in contact with elastic covering 812 such that elastic covering 812 is deformed by bolt 200. In other embodiments, depending on the length of recess 902 and the amount that both 200 extends into recess 902, may not contact elastic covering 812. In any case, with bolt 200 in proximity to sensor 810, a capacitance or inductance measured by deadbolt sensor assembly 800 is changed from a capacitance or inductance measured when is retracted. The processor of deadbolt sensor assembly 800 determines the measured capacitance or inductance, and compares them to threshold value stored in the memory. In some cases, these threshold values are derived from actual measurements while bolt 200 is fully retracted and/or fully extended. The processor may determine capacitance or inductance values periodically, such as once every 30 seconds, or continuously, depending on battery constraints. When the processor determines that the state of deadbolt assembly 222 has change, i.e., locked when bolt 200 has been extended or unlocked when has been retracted. The processor then transmits a status of deadbolt assembly 222 via a transmitter or transceiver coupled to the processor, as shown in FIG. 7.

The methods or algorithms described in connection with the embodiments disclosed herein may be embodied directly in hardware or embodied in processor-readable instructions executed by a processor. The processor-readable instructions may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components.

Accordingly, an embodiment of the invention may comprise a computer-readable media embodying code or processor-readable instructions to implement the teachings, methods, processes, algorithms, steps and/or functions disclosed herein.

While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein need not be performed in any particular order. Furthermore, although elements of the invention may be described or claimed in the singular, the plural is contemplated unless limitation to the singular is explicitly stated.

I claim:

1. An apparatus for determining a status of a deadbolt assembly, comprising:
a sleeve for receiving a deadbolt of a deadbolt assembly when the deadbolt assembly is in a locked state, the sleeve sized and shaped to fit within an existing deadbolt recess formed into a door jamb;
a deadbolt sensor fixedly coupled to a distal end cap of the sleeve, away from a proximal, open end of the sleeve;
a processor coupled to the deadbolt sensor for determining the status of the deadbolt assembly; and
a transmitter coupled to the processor for wireless transmitting the status of the deadbolt.

2. The apparatus of claim 1, further comprising:
a strike plate formed on an open end of the sleeve.

3. The apparatus of claim 1, wherein the deadbolt sensor comprises:
a plunger switch that is activated when the deadbolt is placed into the locked position.

4. The apparatus of claim 1, wherein the deadbolt sensor comprises:
a position sensor for determining a distance between the deadbolt and the position sensor.

5. The apparatus of claim 4, wherein the position sensor comprises a capacitance sensor.

6. The apparatus of claim 1, wherein the deadbolt sensor is mechanically coupled inside the sleeve abutting the distal end cap.

7. The apparatus of claim 1, wherein the deadbolt sensor is mechanically coupled externally to the distal end cap of the sleeve.

8. The apparatus of claim 7, further comprising:
an aperture formed through the distal end cap;
wherein the deadbolt sensor comprises a plunger switch comprising a plunger extending through the aperture, that is pushed inward when the deadbolt is in the locked position and fully extended when the deadbolt is not in the locked position.

9. The apparatus of claim 8, further comprising:
an aperture formed through the distal end cap;
wherein the deadbolt sensor comprises a position sensor that sends wireless signals through the aperture to determine when the deadbolt is in the locked position.

10. The apparatus of claim 9, wherein the position sensor comprises an IR sensor and the wireless signals comprise infra-red light.

11. The apparatus of claim 9, wherein the position sensor comprises an ultrasonic transceiver and the wireless signals comprise ultrasonic sound.
